(19) United States
(12) Patent Application Publication
(10) Pub. No.: US 2019/0226267 A1
(43) Pub. Date: Jul. 25, 2019

(54) WALL INTERIOR SAFE ASSEMBLY HAVING LIGHT SWITCH COVERING PLATE WITH HINGED AND PIVOTING RETRACTION FUNCTIONALITY

(71) Applicant: David B. Batdorf, III, Williamsburg, MI (US)

(72) Inventor: David B. Batdorf, III, Williamsburg, MI (US)

(21) Appl. No.: 15/877,784

(22) Filed: Jan. 23, 2018

(51) Int. Cl. E05G 1/026

(52) U.S. Cl. CPC E05G 1/026; E05G 1/10

(57) ABSTRACT

A hidden wall safe which combines a disguising wall switch plate cover (either operational or nonfunctional) with a controller and actuating mechanism for triggering hinged opening of the cover plate in order to permit access to the safe, such as which can be mounted between a pair of studs associated with an internal wall location. A micro-controller is mounted underneath the wall plate and a separate device, such as for arraying a firearm/pistol with the grip end exposed, form additional components of the finished design.

### FIELD OF THE INVENTION

A hidden wall safe which combines a disguising wall switch plate cover (either operational or nonfunctional) with a controller and actuating mechanism for triggering hinged opening of the cover plate in order to permit access to the safe, such as which can be mounted to any structurally supporting location not limited to mounting between a pair of vertically extending wall studs associated with an inside wall location associated with any interior or exterior wall. A power enabled micro-controller is mounted underneath the wall plate and a separate device, such including a pivoting rod or other support for arraying a firearm/pistol with the grip end exposed, form additional components of the finished design.

### BACKGROUND OF THE INVENTION

The prior art is documented with various types of wall safe assemblies. One example of this is depicted in UK/GB 2 142 083 which teaches a wall safe with a pivotally mounted door 18 via a hinge 20. A wooden door concealing fascia 34 is secured to an outside surface 38 of the safe door 18.

Dombrowski U.S. Pat. No. 5,586,934 discloses a wall safe integrated into a wall air duct and in which a covering grill can be opened to provide access. Other references of note include MaAlexander U.S. Pat. No. 9,010,257, which teaches a locking insert mechanism for securing weapons, valuables or the like. Wolfe U.S. Pat. No. 8,104,313 teaches a security enclosure for a handgun in which the cover rotates outwardly to array the firearm grip end first for ease of removal.

### SUMMARY OF THE INVENTION

The present invention discloses a hidden wall safe, such as which can be mounted between a pair of wall studs or other structurally securing location. The wall safe includes a cover which is pivotally and/or hingedly secured over an access opening via a linkage. The cover can include a normally functioning (or non-functional) light switch plate which, when in place over the safe opening, camouflages the existence of the wall safe.

A microcontroller, such having a battery or other portable power supply, is supported within a housing secured to an interior side of the cover so that the housing seats within the safe opening in a closed and locking position. The switches associated with the housing are operatively connected to the microcontroller and can be manipulated according to a pre-programmed combination in order to trigger displaced opening of the cover.

A wireless outlet relay or receiver is also provided and can be plugged into a remote wall socket for controlling any lamp or other appliance, such as upon triggering of one of the switches integrated into the wall safe cover plate for causing the microcontroller to issue a signal to the wireless receiver (this including such as a standard socket port to which the conventional appliance or lamp is plugged into). In this manner, the switches can be individually employed in a normal use mode (defined as any non-security code triggering event resulting in opening of the wall cover and housing) and to belie their hidden purpose in opening the wall safe. In a safe opening mode, the relay can further function to flash the lamp or other conventional appliance to announce opening of the safe.

Secondary features include the provision of a bracket or arm, typically slaved to the opening linkage, for supporting a pistol or handgun within the safe and, upon opening the cover, causing the handgun to be delivered grip end first through the revealed opening. The handgun support bracket can include a first inwardly turned end for seating within a projecting end of the barrel, along with a secondary support location, such as associated with the stock or hand grip, for retaining the gun during delivery and for permitting quick and effortless retrieval by the user.

### BRIEF DESCRIPTION OF THE DRAWINGS

Reference will now be made to the attached drawings, when read in combination with the following detailed description, wherein like reference numerals refer to like parts throughout the several views, and in which:

FIG. 1 is an environmental view of the hidden wall safe according to one embodiment of the present inventions;

FIG. 2 is a perspective view of the wall safe in a closed position;

FIG. 3 is a succeeding perspective of the wall safe illustrating the combination cover and light switch displaced to an open position permitting delivery of a hand held firearm;

FIG. 4 is a side plan cutaway view of the wall safe in the position of FIG. 3 and better illustrating the hinge construction for opening the cover/switch plate concurrent with pivotal delivery of the handgun;

FIGS. 5 and 6 are side plan cutaway views succeeding FIG. 4 and illustrating the cover and handgun in intermediate and fully retracted positions, respectively;

FIG. 7 is an illustration similar to FIG. 5 according to a further variant (handgun delivery mechanism optional) in which a coil spring is provided at the hinged location for biasing the cover/switch plate toward the open position of FIG. 4; and

FIG. 8 is another illustration similar to FIG. 5 depicting a yet further variant in which a worm gear or other powered driving gear is provided for displacing the cover/switch plate between the open and closed positions.

### DETAILED DESCRIPTION OF THE PREFERRED EMBODIMENTS

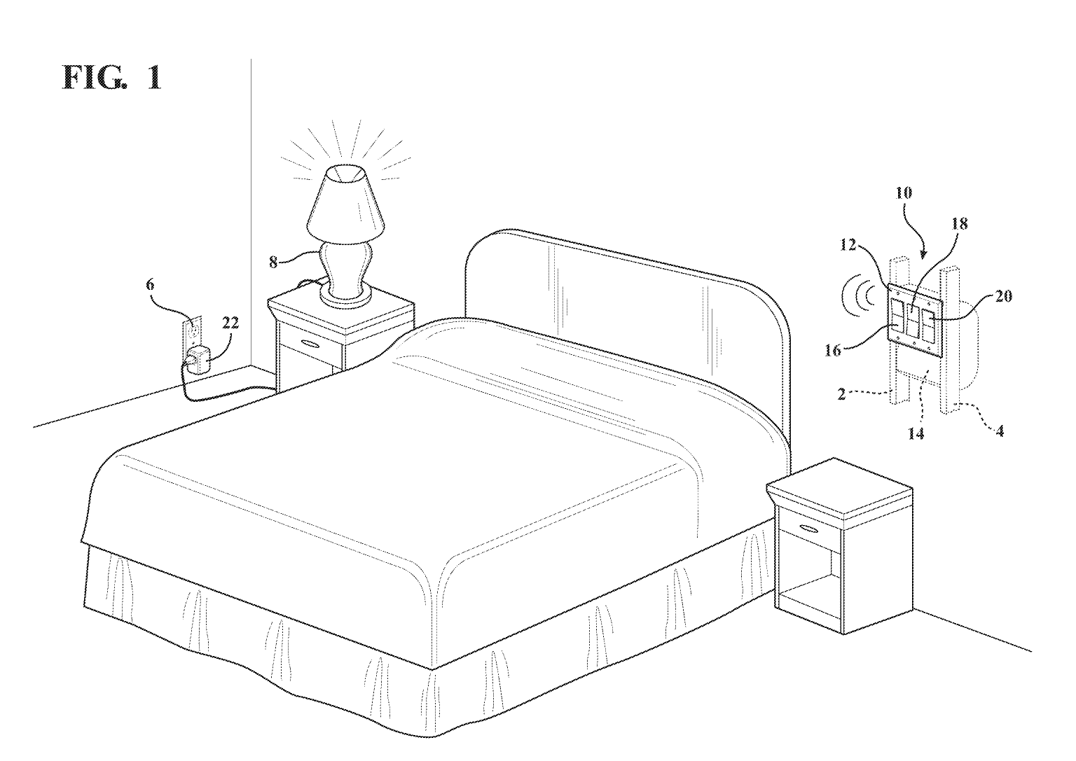

With reference to the appended illustrations, the present invention discloses a hidden safe, a first variant of which is depicted at 10 in FIG. 1 that would ideally be able to be placed in any home wall that is built from 2×4 or 2×6 wooden studs, metal studs, or other vertically extending and structurally supporting location, such as which can be associated with a hidden and wallboard covered location which is not limited to any wall (interior or exterior) or other vertical surface which can define a concealed interior space. As will be further described, the safe is disguised as a covering plate 12 incorporating any plurality of electrical light switches and, upon being actuated, can be displaced or otherwise opened to reveal the interior of the hidden safe main body (shown in phantom at 14 in FIG. 1 mounted between a pair of conventional wall studs 2 and 4, portions of which are likewise shown in phantom). The housing 14 can exhibit any shape or configuration establishing a volume defining interior.

The conventional switch cover plate can incorporate any number of individual switches 16, 18 and 20, with the understanding that any type of single switch, double switch, and possibly four switch models can be employed. Without limitation, the switches can be either decora (rocker switches) or standard switches. The present invention also contemplates more simplified variants using “dummy” switches, with more advanced versions incorporating working light switches and a security coded lock.

FIG. 1 further shows a remote outlet relay 22 which includes one or more standard inlet plug receptacles and which is in turn plugged into a standard 110V or other wall outlet 6. A conventional appliance, such as a lamp 8, is shown and is plugged into the outlet relay 22 which, as will be further described, interfaces with the microcontroller built into the wall safe.

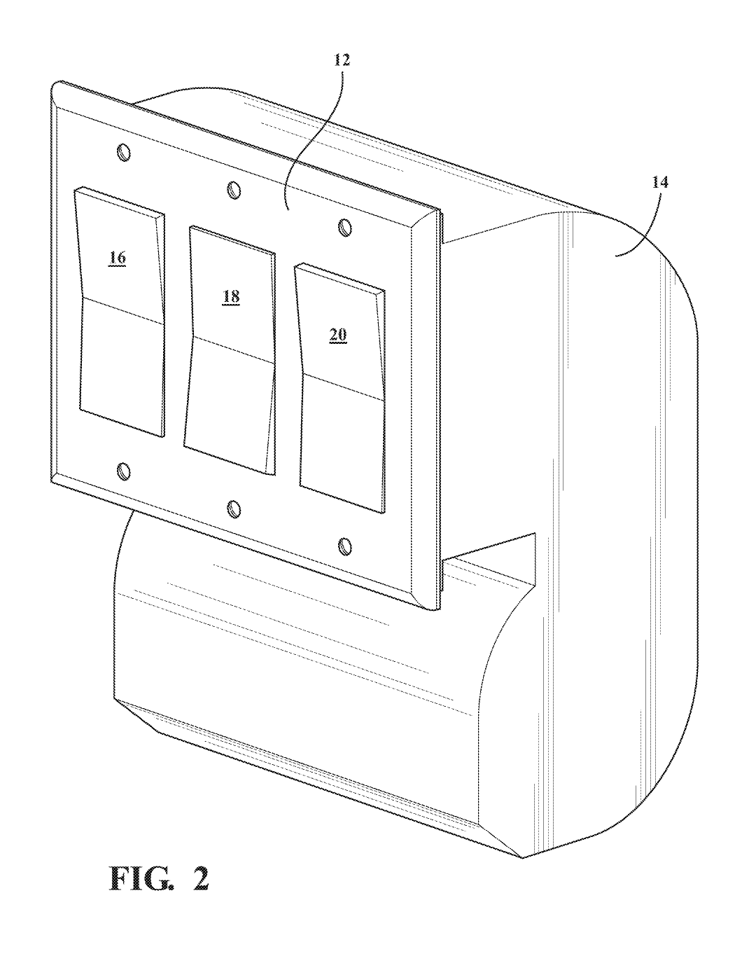

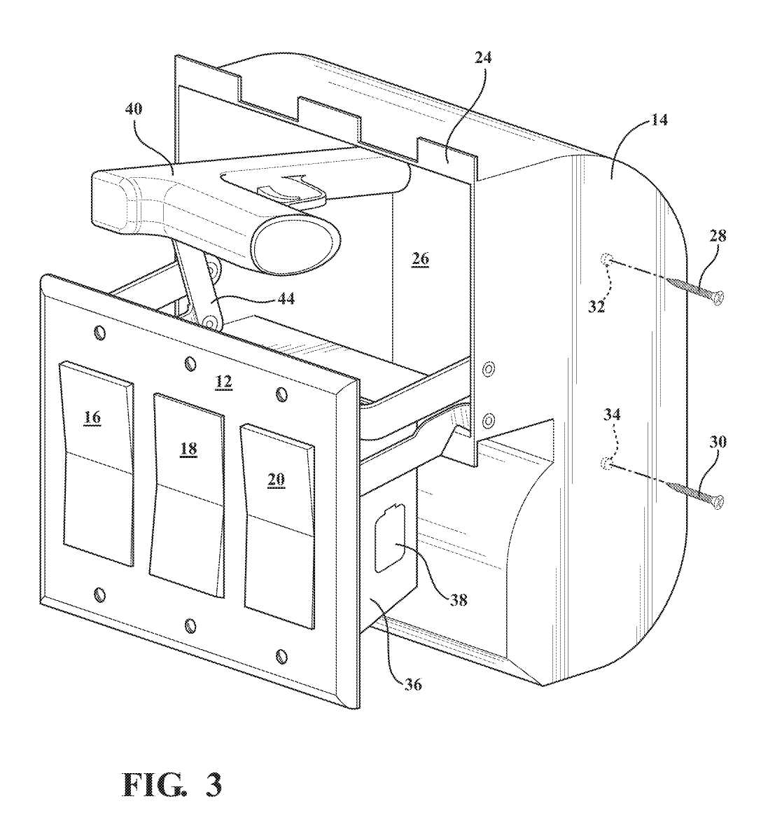

FIG. 2 is a perspective view of the hidden wall safe which illustrates the body 14 in solid representation, the same having a three dimensional length, width and depth and, as shown in FIG. 3, exhibiting a front perimeter defining rim 24 which (upon displacement of the cover 12) reveals an open interior 26. Without limitation, the body 14 can include any steel or other construction, such as which may include but is not limited to any material having impact and/or fire resistance which can utilize a wallboard type material within its composition, and as well as any other desired properties incorporated into the body of the hidden wall safe. The safe 10 can be mounted between the wall studs 2/4 (or other vertical support locations) using any combination of brackets, fasteners or the like. Without further limitation, the body 14 can also be constructed of a durable or other plastic or any other material which supplies the necessary structural or physical desired properties.

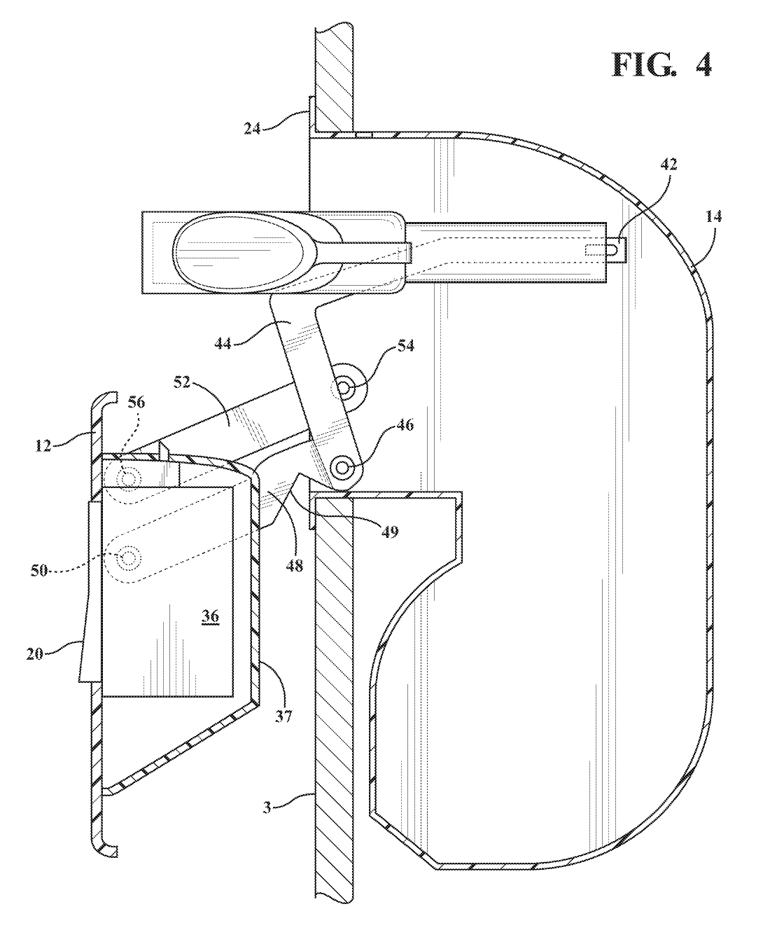

As shown in FIG. 2, a pair of screw fasteners (shown at 28 and 30) are provided and can mount through the studs and receiving apertures (see inner rim patterns 32 and 34), it being understood that initial install of the hidden safe can include a standard sizing of the safe width such that it can fit between a pair of studs 2/4 arranged in standard 16″ or 24″ on center spacing. In this fashion, a conventional wallboard covering (such as a drywall board 3 shown in FIG. 4 et seq.) hides the safe body 14, with the perimeter opening 24 aligning with an aperture formed in the wallboard. In one mounting installation, and upon positioning the body 14 between the studs, the fasteners 28/30 can be mounted from the open interior of the safe body so that the same is anchored between the vertical studs.

A microcontroller 36 is shown and which is mounted, via appropriate fasteners, rivets, or the like, to an inside face of the switch plate cover 12 and so that, with the switch plate in the closed position, the microcontroller seats within the front face perimeter of the safe (FIG. 6). A housing 37 (see FIG. 4) is provided surrounding the microcontroller 36 for enclosing the same. Also shown at 38 is a battery (including access compartment) for powering the microcontroller. Without limitation, any type of alkaline or Lithium ion power supply can be integrated into the microcontroller, it further being understood that a dedicated (wired) power supply can also be provided to the microcontroller.

In one variant, each switch 16, 18 and 20 includes a wire input (hidden) in communication with a processor and circuit board of known construction (not shown) which is integrated into the micro controller 36 for operating each of a security code receiving or memory board, locking mechanism, and wireless receiver which can be built into microprocessor for communicating with the remote outlet relay 22. In this fashion, the wireless receiver controls the lamp 8, or any appliance which can controlled by the switch, again by the relay 22 being plugged into any standard 110 volt home outlet and then having the desired appliance (again lamp 8) plugged into the receiver. In this fashion, and while the receiver turns on or off an appliance, the switches may be put in any desired combination to then unlock and open the safe.

In one non-limiting embodiment, the security code can envision any sequenced toggling of the switches in a progression determined by the owner of the safe (and previously programmed into the microcontroller using a code entry protocol). This progression is saved in the memory board of the microcontroller and, upon being entered, causes the microcontroller output (wireless, Bluetooth, Near Field Communication or the like) to issue an output signal to the relay to open the safe by pivoting the cover away from the opening. The code can be changed if needed by reprogramming the processor, such functionality being built into the system.

One version of the hidden wall safe design of FIGS. 1-6, is configured to support a hand-held firearm such as a pistol or semi-automatic handgun 40. As best shown in FIG. 4, a metal rod or other muzzle end inserting portion 42 is provided extending from an elongated linkage member 44, such having multiple angles and bends and including a reverse bed direction at the muzzle end inserting portion 42 for supporting the handgun 40.

The linkage member 44 is pivotally mounted, at 46, to a fixed interior location of the safe body 14. Additional linkage members include a second member 48 extending from the first linkage member 44 at pivot 46, and mounting at a pivot point 50 to a selected side of the underside housing 37 associated with the cover 12 and integrated microcontroller 36. A further or third linkage member 52 is provided and is secured at further pivot locations 54 (associated with a further fixed location of the safe housing interior 14) and 56 (associated with a further location of the cover underside housing 37).

As further shown, each of the link members 44, 48 and 52 are shown as flattened and elongated plate members which permit inter-articulation in the positions depicted in FIGS. 4-6 and which are configured so as to define a fully opening position in FIG. 4 in which an inner notched location 49 of the second link 48 will seat against and lower abutting location of the perimeter 24. As shown in FIG. 4, a further rotation of the cover 12 about the linkages in a counter clockwise direction will cause the notch 49 to abut the perimeter 24 at the fully open position.

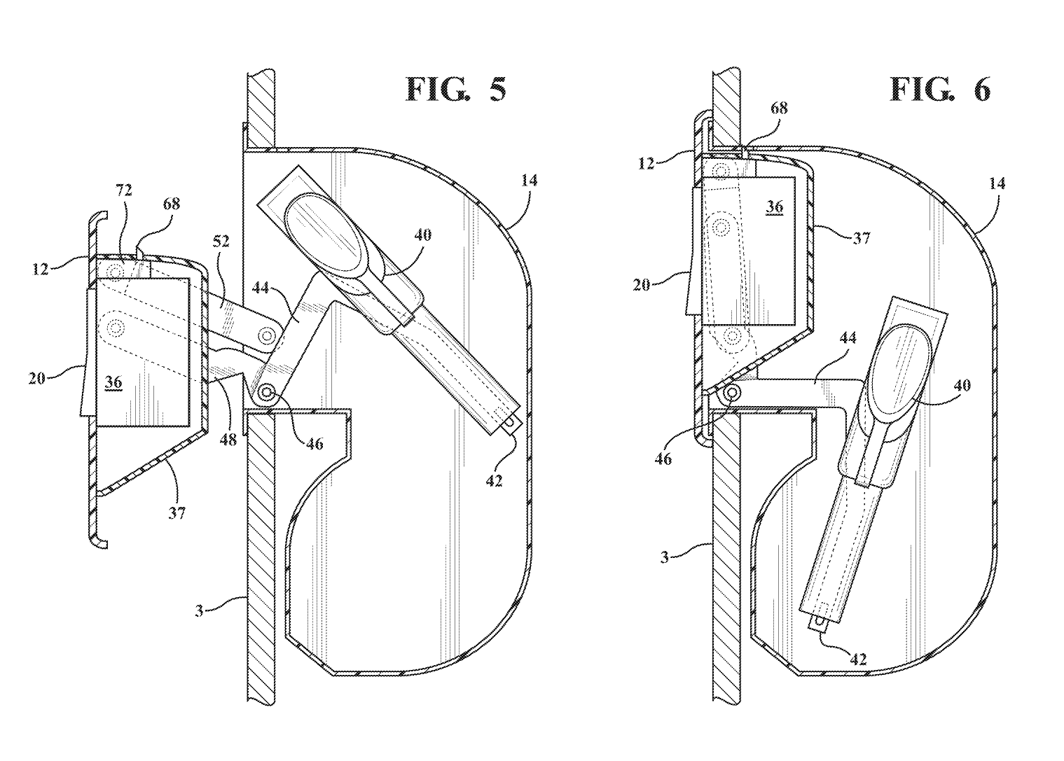

As evidenced by FIG. 3, it is envisioned that pairs of matching linkages 44, 45 and 52 can be integrated into either side of the displaceably supported cover, excepting the handgun supporting linkage 44 which can be associated with a single side linkage arrangement. In this manner, and viewing collectively FIGS. 4-6, the handgun 40 in the fully closed illustration of FIG. 6 is pivoted fully inside the housing interior. FIGS. 4 and 5 further depict fully open and partially open positions, respectively, in which the second and third linkages 48 and 52 control pivoting displacement of the switch cover 12 and underside supported microprocessor so as to displace forwardly and downwardly during opening of the safe, concurrent with the first slaved linkage 44 with end inserting portion 42 supporting the handgun 40 for delivering the same in a position to be easily grasped and withdrawn by the user upon opening the safe. It is further worth noting that the dimensions of the safe interior can be adequate for storing both the deliverable handgun as well as storing additional valuables, with additional variants of the safe designed and dimensioned for either valuable storage or firearm displacing delivery.

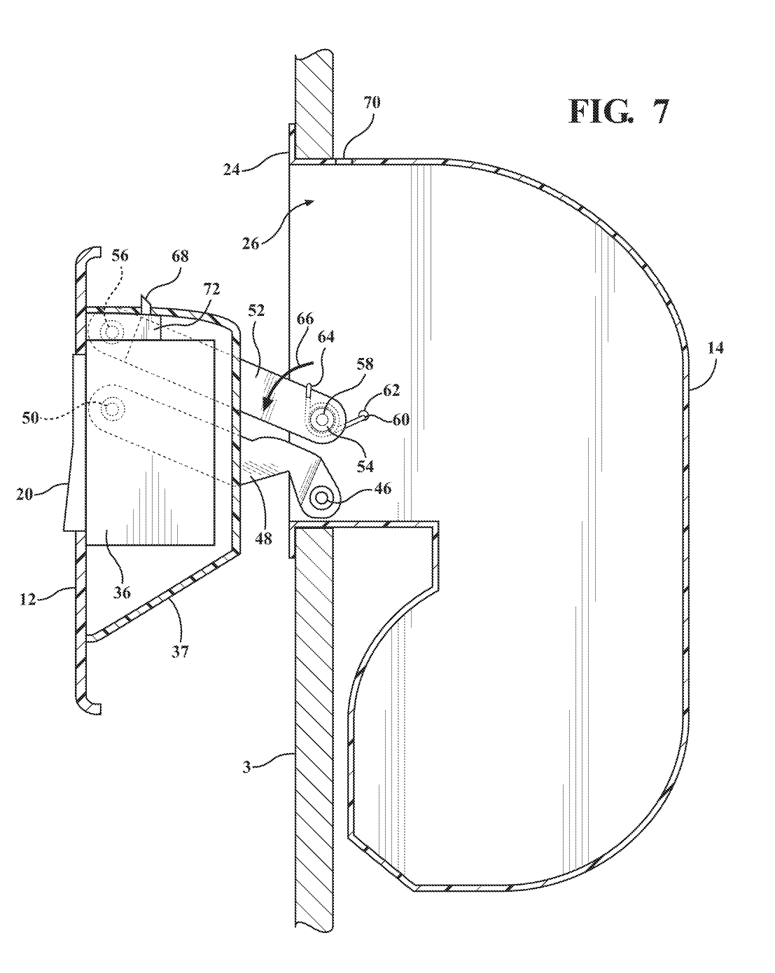

Proceeding to FIG. 7, a cutaway illustration is shown which is similar to FIG. 5 of further variant (handgun delivery mechanism optional) of the present invention, and in which a coil spring 58 is provided at the hinged pivot location 54 for biasing the cover/switch plate toward the open position of FIG. 4. The coil spring 58 includes a first extending leg with curled end 60 seating through an aperture (see inner rim 62) associated with a proximate side wall location of the safe housing 14. A second opposite extending leg with curled end 64 of the coil spring 58 biases the third linkage member 52 in a counter clockwise (ccw) direction 66 in order to bias open the displaceable light switch cover 12.

A catch mechanism can be employed (this is also shown in FIG. 6 and is applicable to the first variant of FIGS. 1-6) and includes a catch 68 associated with a top location of the perimeter housing 37 secured to the underside of switch plate cover 12. The tab 68 mates, in a closed position, with a receiving aperture 70 associated with an aligning top location of the body 14 proximate to the forward housing perimeter 24 when the cover is in the closed position.

A support (such as represented at 72) extends from a top of the main housing defining the microcontroller 36 and integrates the catch 68 so that, and upon actuating the code, retracts the same in order to spring bias the cover to the open position. Without limitation, other triggering or catch/latch mechanisms may be substituted for that shown in order to effectuate opening of the safe.

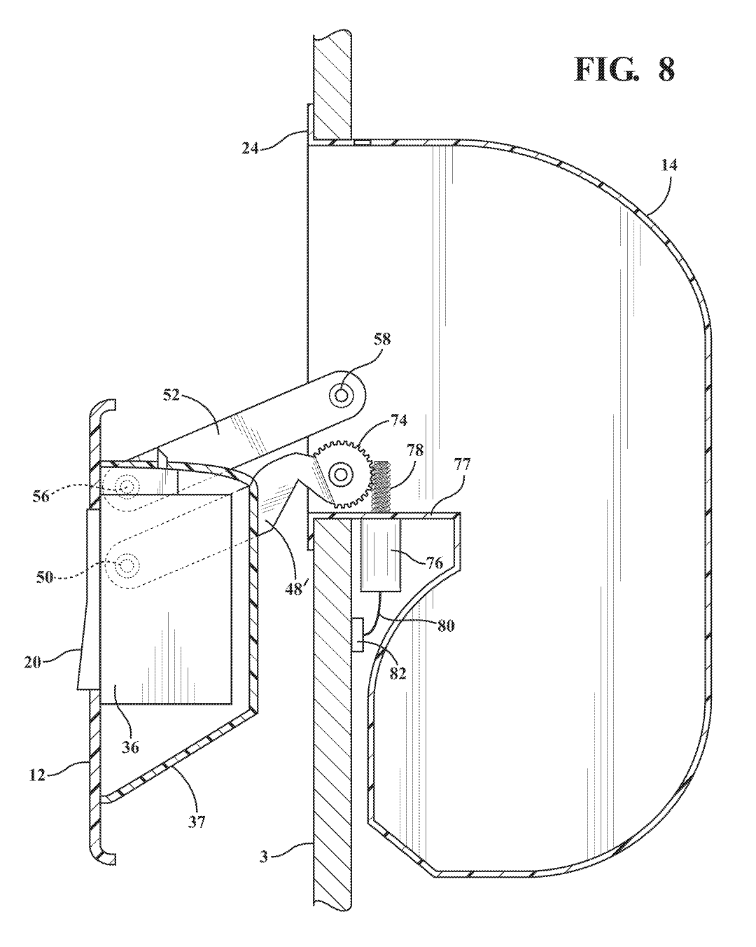

Finally, FIG. 8 is another illustration similar to FIG. 5 depicting a yet further variant in which a worm gear 74 (the present invention also separately contemplating the use of any other suitable actuating mechanism which may or may not include a similar gearing arrangement which is further not limited to any type of powered driving gear). In the illustration provided, the worm gear 74 is built into a redesign of the second link, shown at 48′, and which varies from the version previously depicted at 48 in FIGS. 4 and 7, for displacing the cover/switch plate between the open and closed positions. An electric driven motor is shown at 76 mounted to an internal ledge 77 reconfiguration of the safe housing, from which projects a screw shaft 78 in meshing communication with the worm gear 74. In this manner, actuation of the motor 76, which can include a stand-alone power input and which may be wirelessly activated by the microcontroller 36 via a transmitter/receiver arrangement such as referenced by a separate power input line 80 extending from a proximate located receiver unit 82, provides for displacing of the cover 12 between the opened and closed positions.

In addition to the variants shown, other envisioned models of the hidden wall safe can be used to hide money, medicine, car keys, or anything of appropriate size for the given safe. It is also envisioned that the housing unit for the safe can be constructed out of either plastic or metal depending on what the application is for.

As also described, the hinges are specially designed to allow the switch plate cover to move away from the wall before swinging downward. It is further envisioned that the battery can be replaced if it ever dies while the safe is locked by unscrewing the switch plate cover 12 and replacing the battery while the safe still remains locked and secure.

The switches, power supply, microcontroller, and locking mechanism in one variant are all part of one unit attached to the linkage and hinges, with the switch plate cover 12 screwed onto the microcontroller switch housing 37. This will allow the battery to be replaced while the safe remains locked and for the device to hold the pistol in the fashion described so that the hinges will carry the pistol out of the safe at the same rate that the cover 12 of the opens.

Having described my invention, other and additional preferred embodiments will become apparent to those skilled in the art to which it pertains, and without deviating from the scope of the appended claims. Once such envisioned addition would include incorporating a computer software application (including any type of smartphone or mobile application) which can interface with the built-in microprocessor for the purpose of monitoring the status (has safe been opened and/or successfully closed), and to notify the owner if an unauthorized attempt has been made to open the safe.

I claim:

1. A camouflage wall safe, comprising:
a body having an opening communicating with an interior and adapted to being secured to a support;
a cover integrating a plurality of surface exposed switches, said cover displace-ably secured to said body to extend over a perimeter defined by said opening in a closed position;
an outlet relay at a remote location which is adapted to being plugged into an outlet wall socket, a separate appliance further adapted to being communicated to said outlet relay;
a microcontroller and battery source incorporated into said body in communication with said switches; and
upon being actuated by manipulation of at least one of said plurality of switches in a first protocol, said microcontroller wirelessly instructing a receiver incorporated into said outlet relay to cause the appliance to turn on and off;
said plurality of switches being manipulated in a second protocol so that said microcontroller instructs unlocking and opening of said cover to reveal the opening.

2. (canceled)

3. The wall safe as described in claim 1, further comprising a hinge mechanism for supporting said cover relative to said body in open and closed positions.

4. The wall safe as described in claim 3, said hinge mechanism including a pair of linkages extending between said cover and said body.

5. The wall safe as described in claim 4, further comprising a further linkage slaved to a selected one of said pair of linkages and extending inwardly within said interior of said body, said further linkage adapted to supporting a hand-held firearm for butt end delivery through said opening upon opening of said cover.

6. The wall safe as described in claim 1, further comprising a housing enclosing said microcontroller upon an underside of said cover.

7. The wall safe as described in claim 1, further comprising a power supply built into said microcontroller.

8. The wall safe as described in claim 4, further comprising a biasing spring integrated into one of said pair of linkages at a pivot location to bias said cover in an opening direction.

9. The wall safe as described in claim 1, further comprising a retractable catch extending from a housing supported upon an underside of said cover, said catch being in engagement through an aperture at a location of said body when to said cover in a closed position, actuation of said microcontroller causing said catch to retract during opening of the cover.

10. The wall safe as described in claim 4, further comprising an electric motor integrated into said body and including a threaded drive screw in meshed communication with a gear integrated into a pivot end location of a selected one of said pair of linkages for driving said cover between open and closed positions.

11. The wall safe as described in claim 1, further comprising fasteners adapted for mounting said body to spaced apart vertical wall studs, a wallboard material covering the mounted body with an aperture therein revealing said perimeter opening upon opening of said cover.

12. A camouflage wall safe, comprising:
a body having an opening communicating with an interior and adapted to being secured to a support;
a cover integrating a plurality of surface exposed switches, said cover displace-ably secured to said body to extend over a perimeter defined by said opening in a closed position;
an outlet relay at a remote location which is adapted to being plugged into an outlet wall socket;
a separate appliance further adapted to being communicated to said outlet relay;
a microcontroller and battery source incorporated into said body in communication with said switches;
a hinge mechanism for supporting said cover relative to said body between open and closed positions, said hinge mechanism including interconnecting linkages extending between said cover underside and interior edge supporting locations defining said interior of said body facilitating displacement of said cover; and
upon being actuated by manipulation of at least one of said plurality of switches in a first protocol, said microcontroller wirelessly instructing a receiver incorporated into said outlet relay to cause the appliance to turn on and off;
said plurality of switches being manipulated in a second protocol so that said microcontroller instructs unlocking and opening of said cover to reveal the opening.

13. A camouflage wall safe, comprising:
a body having an opening communicating with an interior and adapted to being secured to a support;
a cover integrating a plurality of surface exposed switches, said cover displace-ably secured to said body to extend over a perimeter defined by said opening in a closed position;
an outlet relay at a remote location which is adapted to being plugged into an outlet wall socket;
a separate appliance further adapted to being communicated to said outlet relay;
a microcontroller and battery source incorporated into said body in communication with said switches;
a hinge mechanism for supporting said cover relative to said body between open and closed positions, said hinge mechanism including interconnecting linkages extending between said cover underside and interior edge supporting locations defining said interior of said body facilitating displacement of said cover;
a further linkage slaved to said hinge mechanism linkages which is adapted to support, at an extending end, a weapon;
upon being actuated by manipulation of at least one of said plurality of switches in a first protocol, said microcontroller wirelessly instructing a receiver incorporated into said outlet relay to cause the appliance to turn on and off;
said plurality of switches being manipulated in a second protocol so that said microcontroller instructs unlocking and opening of said cover to reveal the opening, said further linkage causing said weapon to be displaced between a first stored position within said body interior and a second delivered position in which a portion of said weapon is adapted to project forwardly of said opening.
